(19) United States
(12) Patent Application Publication
(10) Pub. No.: US 2023/0385916 A1
(43) Pub. Date: Nov. 30, 2023

(54) Three-Dimensional (3D) Image Modeling Systems and Methods for Automatically Generating Virtual 3D Store Environments

(71) Applicant: The Procter & Gamble Company, Cincinnati, OH (US)

(72) Inventors: Diana Jobson Cheshire, Wyoming, OH (US); Joshua Allen Williams, Cincinnati, OH (US)

(21) Appl. No.: 17/825,067

(22) Filed: May 26, 2022

(51) Int. Cl. G06Q 30/06; G06T 19/00

(52) U.S. Cl. CPC G06Q 30/0643; G06T 19/006; G02B 27/017

(57) ABSTRACT

Three-dimensional (3D) image modeling systems and methods are described for automatically generating virtual 3D store environments. The 3D image modeling systems and methods comprise loading, from a computer memory, a product set of 3D imaging assets including product texture images and standard product model(s). A virtual 3D area is generated by a 3D engine inputting a matrix file that depicts one or more 3D products. The 3D engine positions the one or more virtual 3D products based on positioning data in the matrix file. A virtual 3D store environment is generated based on the virtual 3D area and a 3D structural model. The virtual 3D store environment is configured for rendering as a photorealistic environment in virtual 3D space.

### FIELD OF THE DISCLOSURE

The present disclosure generally relates to three-dimensional (3D) image modeling systems and methods, and more particularly to, 3D image modeling systems and methods for automatically generating virtual 3D store environments.

### BACKGROUND

In the consumer goods industry, three-dimensional (3D) models of physical products or packages corresponding to real-world products or packages are useful in virtual reality shopping environments, e-commerce environments and gaming environments. Today, creating these models is a costly and time consuming process that involves manually modeling or scanning the actual 3D shape to create a surface mesh and applying textures representing the surface colors, materials and decoration. Artists must adjust models by hand to match the visual acuity requirements for the store virtual reality shopping environments, e-commerce environments, or gaming environments where the 3D models will be used. As consumer products often change, this must be repeated frequently resulting in lost effort and lost investment, which has been a barrier to widespread adoption of virtual reality shopping environments. In addition, such activity is computer resource intensive, requiring multiple iterations or versions of 3D models, and related data, all of which impacts computer memory storage and processing.

For example, current processes for building a virtual e-commerce space is involves manual virtual asset manipulation. This includes manual techniques involving dragging and positioning products within the virtual e-commerce space one at a time and cross referencing versus a spreadsheet or store image. Such manual process typically involves human error and storage of various iterations or versions of models in order to achieve results. For example, it can take multiple weeks of effort to generate a virtual e-commerce space with hundreds of products, all of which may require large amounts of computing resources, such as memory storage and computer processing.

For the foregoing reasons, there is a need for 3D image modeling systems and methods for automatically generating virtual 3D store environments.

### SUMMARY

The 3D image modeling systems and methods described herein provide for rapid, automatic creation or generation of high-quality, realistic virtual 3D store environments from 3D imaging assets and/or metadata, such as dimensional data. That is, implementation of the 3D image modeling systems and methods described herein allow for such creation or generation in a fraction of the time compared with conventional, prior art 2D and/or 3D modeling techniques. In particular, highly accurate (e.g., in terms of dimensions, physical appearance, etc.) virtual 3D store environments—that include virtual 3D areas, such as shelving units depicting packages and products—can be rendered efficiently and for low cost, and can reduce the impact on computing resources. Such virtual 3D store environments—that comprise virtual packages and products— can be used in developing e-commerce environments, gaming environments, or otherwise virtual environments (including in virtual reality (VR) and augmented reality (AR) environments), and can be much more easily modified based on changes in spacing or configuration of the virtual 3D store environment and/or product or packaging design as needed, compared to prior art techniques.

Generally, the 3D modeling systems and methods described herein provide a unique data-driven solution, and an automated platform, for automatically generating virtual 3D store environments. The 3D modeling systems and methods described herein may be used with various categories of products and packages, e.g., including those in the consumer goods industry. Such products and packages may include those in consumer products industry including hair care, grooming industry, laundry, toiletry, etc. and the like. For example, a highly accurate, photorealistic, virtual 3D model of a product and/or package (e.g., a shampoo bottle) may be generated, assembled, and/or otherwise created from 3D imaging assets and dimensional data and then placed in a newly generated virtual 3D store environment. In this way, the virtual 3D models can become part of a product and package data record for perpetual reuse in creating new and/or addition virtual 3D models for new, additional, or future products or packages, for inclusion in, and for generation of, virtual 3D store environment(s). The virtual 3D store environment(s) may then be placed in a 3D engine, such as a gaming engine, for interaction and/or exploration by users.

In various aspects, a matrix is defined and used to automate generation of virtual 3D store environment(s). The matrix file may be a planogram matrix file, which can be a PSA file (having a “.psa” file extension) as created by the BLUEYONDER SPACE PLANNING program. The matrix file may comprise metadata that defines objects and/or assets of a virtual product area. The metadata may include, by way of non-limiting example, Global Trade Item Number (GTIN) information, pricing information, position information, product dimensional data, pack format data, 2D images, 3D images, and/or other data, for example, as described herein.

Still further, in various aspects, the matrix file may be analyzed, interpreted, executed, or otherwise used by or within a gaming engine (e.g., such as the UNITY gaming engine) to automate highly accurate positioning of individual objects or otherwise 3D assets (e.g., products) in virtual 3D store environment(s). In various aspects, a virtual 3D store environment may comprise a virtual shelf environment that depicts products or packages resting on shelving units. The matrix file may further enable interactivity, lighting, and/or physical interactions or physical motion amongst the various individual objects or otherwise 3D assets (e.g., products or packages) within the virtual 3D store environment(s).

Still further, the matrix file may be analyzed, interpreted, executed, or otherwise used to auto populate environment information, which may comprise price tag or pricing information of 3D assets, such as 3D products in a virtual 3D store environment. The matrix file may be used to interpret placement of tags on such under appropriate facings, fixture, and/or sections of a given product, and may differ based on the type of product or given stock keeping unit (SKU) item.

More generally, the 3D image modeling systems and methods provides improved efficiency, quality, and accuracy over previous methods. That is, the 3D image modeling systems and methods described herein provide for an enhanced ruled-based method for automatically generating virtual 3D store environments that provide accurate versions of real-world stores in terms of 3D positioning, lighting, placement, physics, and/or interaction for, between, or among 3D objects in the virtual 3D area or space. For example, the disclosed systems and methods implement an algorithm for 3D interactivity and realism such as lighting, product interactivity, and/or pricing placement of 3D assets or objects in a virtual 3D environment. In addition, the 3D image modeling systems and methods described herein allow for immediate updates and changes (e.g., real-time or near real-time updates and changes) as product manufacturers and/or retail stores adjust their respective products and promotions, e.g., via annual resets or initiative launches. For example, the disclosed 3D image modeling systems and methods can render a virtual 3D store environment in under 10 minutes whereas previous methods could take from one day to two weeks to render the same virtual 3D store environment. By further comparison, generation of 2D-only e-commerce spaces can take upwards of 15 minutes to generate. Even with the additional processing time, however, such 2D-only e-commerce spaces are limited and lack sufficient detail regarding 3D aspects (e.g., interaction and lighting) among the various products or other assets within the virtual e-commerce space. By contrast, the 3D image modeling systems and methods described herein eliminate these inefficiencies and further provide improvements to execution and memory storage of underlying computing devices.

Accordingly, as described herein for some aspects, a 3D image modeling system is configured to automatically generate virtual 3D store environments. The 3D image modeling system may comprise one or more processors. The 3D image modeling system may further comprise a virtual 3D environment builder script comprising computing instructions configured to execute on the one or more processors. The 3D image modeling system may further comprise a memory configured to store 3D imaging assets accessible by the one or more processors and the computing instructions of the virtual 3D environment builder script. The computing instructions of the virtual 3D environment builder script, when executed by the one or more processors, cause the one or more processors to load, from the memory, a product set of 3D imaging assets comprising product texture images and one or more standard product models. The computing instructions of the virtual 3D environment builder script, when executed by the one or more processors, further cause the one or more processors to load, from the memory, a structural set of 3D imaging assets comprising a 3D structural model. The computing instructions of the virtual 3D environment builder script, when executed by the one or more processors, further cause the one or more processors to load, from the memory, a matrix file comprising metadata of a virtual product area. The computing instructions of the virtual 3D environment builder script, when executed by the one or more processors, further cause the one or more processors to generate, by a 3D engine inputting the matrix file, a virtual 3D area depicting one or more 3D products. The 3D engine positions the one or more virtual 3D products based on positioning data in the matrix file. The computing instructions of the virtual 3D environment builder script, when executed by the one or more processors, further cause the one or more processors to generate a virtual 3D store environment based on the virtual 3D area and the 3D structural model. The virtual 3D store environment may be configured for rendering as a photorealistic environment in virtual 3D space.

In addition, as described in various aspects herein, a 3D image modeling method is disclosed for automatically generating virtual 3D store environments. The 3D image modeling method may comprise loading, from a memory, a product set of 3D imaging assets comprising product texture images and one or more standard product models. The 3D image modeling method may further comprise loading, from the memory, a structural set of 3D imaging assets comprising a 3D structural model. The 3D image modeling method may further comprise loading, from the memory, a matrix file comprising metadata of a virtual product area. The 3D image modeling method may further comprise generating, by a 3D engine inputting the matrix file, a virtual 3D area depicting one or more 3D products. The 3D engine positions the one or more virtual 3D products based on positioning data in the matrix file. The 3D image modeling method may further comprise generating a virtual 3D store environment based on the virtual 3D area and the 3D structural model. The virtual 3D store environment may be configured for rendering as a photorealistic environment in virtual 3D space.

In addition, as described in various aspects herein, a tangible, non-transitory computer-readable medium is disclosed, that stores instructions for automatically generating virtual 3D store environments. The instructions, when executed by one or more processors, cause the one or more processors to load, from a memory, a product set of 3D imaging assets comprising product texture images and one or more standard product models. The instructions, when executed by one or more processors, further cause the one or more processors to load, from the memory, a structural set of 3D imaging assets comprising a 3D structural model. The instructions, when executed by one or more processors, further cause the one or more processors to load, from the memory, a matrix file comprising metadata of a virtual product area. The instructions, when executed by one or more processors, further cause the one or more processors to generate, by a 3D engine inputting the matrix file, a virtual 3D area depicting one or more 3D products. The 3D engine positions the one or more virtual 3D products based on positioning data in the matrix file. The instructions, when executed by one or more processors, further cause the one or more processors to generate a virtual 3D store environment based on the virtual 3D area and the 3D structural model. The virtual 3D store environment may be configured for rendering as a photorealistic environment in virtual 3D space.

In accordance with the above, and with the disclosure herein, the present disclosure includes improvements in computer functionality or in improvements to other technologies at least because, e.g., the disclosed 3D image modeling systems and methods automatically generate photorealistic, virtual 3D store environment(s) with improved accuracy as to 3D physical interactions or physical motion, accuracy, and positioning, among other 3D attributes. In this way, the 3D image modeling systems and methods may flexibly, and efficiently, produce photorealistic image(s), as described herein, which improves the performance, speed, and efficiency of the underlying computing device(s), e.g., processors, memories, and/or servers, because such computing devices are freed from computational and memory intensive tasks regarding manually adjusting 3D models to match visual acuity requirements for a given virtual environment, and creating various versions (including intermediate versions) of new 3D models corresponding to real-world products or product packages each time a change is made to the product or product package, which therefore avoids the use and reuse of memory and processor resources required to store and execute such 3D models. That is, the present disclosure describes improvements in the functioning of the computer itself or “any other technology or technical field” because the computing devices upon which the 3D image modeling systems and methods are implemented are enhanced by a virtual 3D environment builder script that increase the fidelity and efficiency of design of photorealistic images representing real-world virtual 3D store environment. This improves over the prior art at least because prior art systems resulted in low fidelity 3D models that were difficult to re-use, and, therefore required increased memory and processing power, at least over time, to develop and modify designs for real-world virtual 3D store environments. In contrast, the systems and methods described herein utilize less memory and processing power to produce a high-fidelity 3D models of virtual 3D store environments as compared to prior art systems and methods. Moreover, less memory is required for both saving and accessing the 3D models created by the systems and methods described herein, as compared to prior art systems and methods. For example, the processor and memory resources used by the 3D modeling systems and methods are typically less than that of prior art systems for the same design over time. Not only do the disclosed 3D modeling systems and methods use fewer computational resources, they are much faster, and therefore more efficient, for generating virtual 3D store environment that themselves may include virtual 3D models and/or photorealistic images representing real-world product(s) or product package(s). In one example, the disclosed 3D modeling systems and methods reduced the amount of time required to create virtual 3D store environment from 2 weeks (i.e., when using prior art systems and methods) to under 10 minutes (using the disclosed 3D image modeling systems and methods).

In addition, the present disclosure includes improvements in computer functionality or in improvements to other technologies at least by providing decreased processor usage by reducing the processing required from 2-15 days to less than 10 minutes. This also improves the underlying computing device(s)′ (e.g., a server's and/or other device's) power consumption because the processing or compute cycles, and the electricity used to execute such cycles, is greatly reduced compared to prior art methods.

Further, the present disclosure includes improvements in computer functionality or in improvements to other technologies at least by providing reduced storage of 3D and/or 2D assets that would normally be required or generated as intermediate artifacts of manual manipulation of such assets, which normally requires multiple versions of 3D and/or 2D assets to be stored and saved in memory during a manual creation process.

Still further, the present disclosure includes improvements in computer functionality or in improvements to other technologies at least by reducing errors with 3D generated models and/or environments. That is, errors are reduced by eschewing manual manipulation that can create defects and/or inconsistences in the 3D generated models and/or environments. Because of this, the physics and collisions between or among the 3D models within their environments is greatly enhanced when the virtual 3D store environment is rendered as a photorealistic environment in virtual 3D space.

In addition, with respect to certain aspects, the present disclosure includes effecting a transformation or reduction of a particular article to a different state or thing, e.g., generating a virtual 3D store environment, which can be modeled based on a real-world area and from 3D imaging assets and metadata of a matrix file.

Still further, the present disclosure includes specific limitations and features other than what is well-understood, routine, conventional activity in the field, which includes adding unconventional steps that confine the disclosure herein to a particular useful application, e.g., for automatically generating virtual 3D store environments.

Additional advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an aspect of a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1 illustrates an example three-dimensional (3D) image modeling system configured to automatically generate virtual 3D store environments, in accordance with various aspects disclosed herein.

FIG. 2A illustrates a flow diagram depicting a portion of a three-dimensional (3D) image modeling method for automatically generating virtual 3D store environments, in accordance with various aspects disclosed herein.

FIG. 2B illustrates a further flow diagram depicting a further portion of the three-dimensional (3D) image modeling method of FIG. 2A for automatically generating virtual 3D store environments, in accordance with various aspects disclosed herein.

FIG. 3 illustrates a visualization or rendering of various possible product set of 3D imaging assets, in accordance with various aspects disclosed herein.

FIG. 4A illustrates an example virtual 3D area depicting one or more 3D products, in accordance with various aspects disclosed herein.

FIG. 4B illustrates example virtual 3D store environment based on the virtual 3D area of FIG. 4A, in accordance with various aspects disclosed herein.

FIG. 4C illustrates a further example virtual 3D store environment based on the virtual 3D area of FIG. 4A and as viewed via a virtual reality (VR) device, and in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION

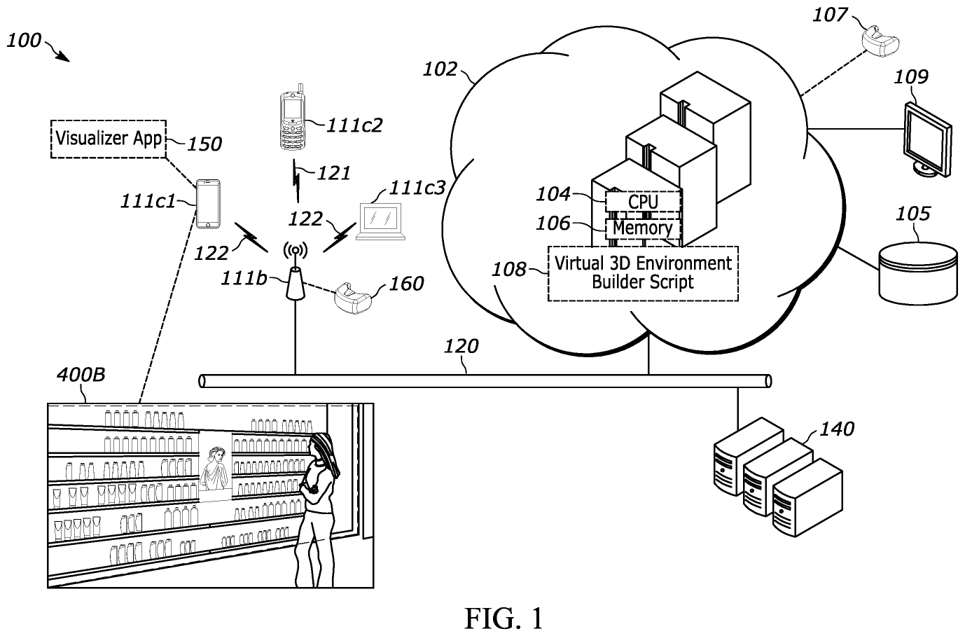

FIG. 1 illustrates an example three-dimensional (3D) image modeling system 100 configured to automatically generate virtual 3D store environments, in accordance with various aspects disclosed herein. In the example aspect of FIG. 1, 3D image modeling system 100 includes server(s) 102, which may be referred to herein as “modeling server(s),” and which may comprise one or more computer servers. In various aspects, server(s) 102 comprise multiple servers, which may comprise multiple, redundant, or replicated servers as part of a server farm. In still further aspects, server(s) 102 may be implemented as cloud-based servers. For example, server(s) 102 may be a cloud-based platform such as MICROSOFT AZURE, AMAZON AWS, GOOGLE CLOUD platform, or the like.

Server(s) 102 may include one or more processor(s) 104 as well as one or more computer memories 106. Memories 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, Micros cards, and others. Memorie(s) 106 may store an operating system (OS) (e.g., Microsoft Windows, Linux, Unix, etc.) capable of facilitating the functionalities, apps, methods, or other software as discussed herein. Memorie(s) 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the software, instructions, scripts, applications, software components, or APIs may include, otherwise be part of, a virtual 3D environment builder script 108 and/or other such software, where each are configured to facilitate their various functionalities as described herein. It should be appreciated that one or more other applications or scripts, such as those described herein, may be envisioned and that are executed by processor(s) 104. In addition, while FIG. 1 shows implementation of the systems and methods on server(s) 102, it should be appreciated that the systems and methods herein may be implemented by a non-server computing system that includes one or more processors.

Processor(s) 104 may be connected to memories 106 via a computer bus responsible for transmitting electronic data, data packets, or otherwise electronic signals to and from processor(s) 104 and memories 106 in order to implement or perform the machine readable instructions, methods, processes, scripts, elements or limitations, as illustrated, depicted, or described for the various flowcharts, illustrations, diagrams, figures, and/or other disclosure herein.

Processor(s) 104 may interface with memory 106 via the computer bus to execute the operating system (OS). Processor(s) 104 may also interface with computer memory 106 via the computer bus to create, read, update, delete, or otherwise access or interact with the data stored in memory, including in memories 106 and/or the database 105 (e.g., a relational database, such as Oracle, DB2, MySQL, or a NoSQL based database, such as MongoDB). The data stored in memories 106 and/or the database 105 may include all or part of any of the scripts, data, or information described herein, including, for example the virtual 3D environment builder script 108, and/or the 3D imaging assets as accessible by the virtual 3D environment builder script 108.

As described herein a “memory” may refer to either memory 106 and/or database 105. Such memory may be configured to store 3D imaging assets accessible by processor(s) 104, scripts, application, or other software, e.g., including a virtual 3D environment builder script 108 described herein.

In some aspects, database 105 may be a product lifecycle management (PLM) database or system. Generally, a PLM database or system is implemented as an information management system that can integrate data, processes, and other business systems within an enterprise or platform, such as the platform depicted for 3D image modeling system 100. A PLM database or system generally includes software for managing information (e.g., 3D imaging assets) throughout an entire lifecycle of a product/package in an efficient and cost-effectivities manner. The lifecycle may include lifecycle stages from ideation, design and manufacture, through service and disposal. In some aspects, database 105 may store digital PLM objects (e.g., digital 2D and/or 3D imaging assets as described herein). This may include a product set of 3D imaging assets, a structural set of 3D imaging assets, and/or a matrix file comprising metadata of a virtual product area as described herein. Such digital objects or assets can represent a real-world physical parts, assemblies(s), or documents, customer requirements or supplier parts, a change process, and/or other data types relating to a lifecycle management and development of a product and/or package. For example, digital objects or assets can include computer-aided design (CAD) file(s) that depict or describe (e.g., via measurements, sizes, etc.) parts, components, or complete (or partially complete) models or designs of products and/or packages. Generally, non-CAD files can also be included in database 105. Such non-CAD files can include text or data files describing or defining parts, components, pricing information, and/or product or package specifications, vendor datasheets, or emails relating to a design. For example, a PLM database or system can index and access text contents of a file, which can include metadata or other information regarding a product or package for design purposes.

In addition, PLM objects or assets, and/or corresponding data records, such as those that may be stored in database 105, can contain properties regarding an object's or an asset's parameters or aspects of its design lifecycle. For example, PLM database or systems can generally store different classes of objects or assets (such primarily parts (e.g., as CAD files)), documents, and change forms) with distinct properties and behaviors. Such properties can include metrics or metadata such as part/document number, item category, revision, title, unit of measure, bill of materials, cost, pricing, mass, dimensions, regulatory compliance details, file attachments, and other such information regarding product(s), and/or package(s) of a company. In addition, such PLM objects or assets may be linked, e.g., within database 105 (e.g., as a relational database), to other objects or assets within database 105 for the association of or otherwise generation or construction of a product structure. In this way, a PLM database can be flexibly used to identify objects and assets, create and define relationships among such objects and assets. Such flexibility provides a basis for the creation, customization, revision, and/or reuse of virtual models (e.g., virtual 3D models or structural models), as described herein, and also the 3D and/or 2D imaging assets on which they are based.

For example, in some aspects, processor(s) 104 may store 3D and/or 2D imaging assets, matrix files, and/or virtual 3D model(s) in memory 106 and/or database 105 such that virtual 3D model(s) or structural models are accessible to a virtual 3D environment builder script 108 or a visualization editor. In this way, a virtual 3D environment builder script 108 or the visualization editor, in a new or next iteration of a product lifecycle or introduction of new product lifecycle, may generate one or more new or additional 3D and/or 2D imaging assets, matrix files, and/or virtual 3D models corresponding to one or more new or additional real-world products or product packages, or one or more new or additional virtual 3D models corresponding to updated versions of existing real-world products or product packages.

In various aspects described herein, database 105, implemented as a PLM database or system, can support CAD files for components or parts of existing or future (i.e., to be designed or physically manufactured) products, packages, structures, or other models as described herein. Such a PLM database or system can be implemented, for example, via third party software such as ALTIUM DESIGNER software, ORCAD component information system (CIS) software, or the like.

While a PLM based database and system are described in various aspects herein, it is to be understood that other database or memory management systems (e.g., standard relational databases, NoSQL databases, etc.) may likewise be used in accordance with the disclosure of the 3D image modeling systems and methods herein. As a non-limiting example, a PLM based database and/or system may comprise a “data lake” or the like, where a data lake or similar such database can comprise a system or repository of data stored in its natural/raw format, for example, as object blobs, raw bytes, and/or data files.

Further, with respect to FIG. 1, server(s) 102 may further include a communication component configured to communicate (e.g., send and receive) data via one or more external/network port(s) to one or more networks or local terminals, such as computer network 120 and/or terminal 109 (for rendering or visualizing) as described herein. In some aspects, server(s) 102 may include a client-server platform technology such as ASP.NET, Java J2EE, Ruby on Rails, Node.js, Flask, or other web service or online API, responsive for receiving and responding to electronic requests. The server(s) 102 may implement the client-server platform technology that may interact, via the computer bus, with memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein. According to some aspects, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120.

Server(s) 102, via processor(s) 104, may further include, implement, or launch a visualization editor, or otherwise operator interface, to render models or photorealistic images, present information to a user, and/or receive inputs or selections from the user. As shown in FIG. 1, the user interface may provide a display screen or graphic display (e.g., via terminal 109).

Server(s) 102 may also provide I/O components (e.g., ports, capacitive or resistive touch sensitive input panels, keys, buttons, lights, LEDs), which may be directly accessible via or attached to server(s) 102 or may be indirectly accessible via or attached to terminal 109. According to some aspects, a user may access the server 102 via terminal 109 to render models or photorealistic images (e.g., via a visualization editor), review information, make changes, input data, and/or perform other functions. VR headset 107 may further be used to render models or photorealistic images (e.g., via a display screen of the VR headset), review information, make changes, input data, and/or perform other functions for purposes of designing and assessing 3D environments as described herein.

As described above herein, in some aspects, server(s) 102 may perform the functionalities as discussed herein as part of a “cloud” network or may otherwise communicate with other hardware or software components within the cloud to send, retrieve, or otherwise analyze data or information (e.g., virtual 3D model(s)) as described herein.

In various aspects herein, a computer program, script, code, or application, (e.g., a virtual 3D environment builder script 108) may comprise computer-readable program code or computer instructions, in accordance with aspects herein, and may be stored on a computer usable storage medium, or tangible, non-transitory computer-readable medium (e.g., standard random access memory (RAM), an optical disc, a universal serial bus (USB) drive, or the like). Such comprise computer-readable program code or computer instructions may be installed on or otherwise adapted to be executed by processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code or scripts may be implemented in any desired program language, and may be implemented as machine code, assembly code, byte code, and/or interpretable source code or the like (e.g., via Golang, Python, C, C++, C#, Objective-C, Java, Scala, ActionScript, JavaScript, HTML, CSS, XML, etc.). For example, as described herein, server(s) 102, implementing processor(s) 104, may execute one or more virtual 3D environment builder script 108 to generate virtual 3D store environments as described herein.

In the example aspect of FIG. 1, modeling server(s) 102 are communicatively connected, via computer network 120. Computer network 120 may comprise a packet based network operable to transmit computer data packets among the various devices and servers described herein. For example, computer network 120 may consist of any one or more of Ethernet based network, a private network, a local area network (LAN), and/or a wide area network (WAN), such as the Internet.

In some aspects, modeling server(s) 102 may download or retrieve 3D and/or 2D imaging assets over computer network 120. For example, 3D and/or 2D imaging assets may be downloaded, by modeling server(s) 102, from remote server(s) 140 which may store 3D and/or 2D imaging assets. Remote server(s) 140 may comprise a data lake or PLM database as described herein. Additionally, or alternatively, remote server(s) may be those of a third-party or of the company designing or developing product(s) and/or product package(s) as described herein. In some aspects, a portion or subset of 3D and/or 2D imaging assets may comprise dimensional data required to design product(s) and/or product package(s). Such data or information may be retrieved from the remote server(s) 140.

As shown in FIG. 1, imaging server(s) 102 are communicatively connected, via computer network 120 to one or more user computing devices 111c1-111c3 via base station 111b. In some aspects, base station 111b may comprise cellular base stations, such as cell towers, communicating to the one or more user computing devices 111c1-111c3 via wireless communications 121 based on any one or more of various mobile phone standards, including NMT, GSM, CDMA, UMMTS, LTE, 5G, or the like. Additionally, or alternatively, base station 111b may comprise routers, wireless switches, or other such wireless connection points communicating to the one or more user computing devices 111c1-111c3 via wireless communications 122 based on any one or more of various wireless standards, including by non-limiting example, IEEE 802.11a/b/c/g (WIFI), the BLUETOOTH standard, or the like.

Any of the one or more user computing devices 111c1-111c3 may comprise mobile devices and/or client devices for accessing and/or communications with imaging server(s) 102. Such mobile devices may comprise one or more mobile processor(s) and/or an imaging device for capturing images. In various aspects, user computing devices 111c1-111c3 may comprise a mobile phone (e.g., a cellular phone), a tablet device, a personal data assistance (PDA), or the like, including, by non-limiting example, an APPLE iPhone or iPad device or a GOOGLE ANDROID based mobile phone, tablet, and/or a VR headset.

In various aspects, the one or more user computing devices 111c1-111c3 may implement or execute an operating system (OS) or mobile platform such as APPLE iOS and/or GOOGLE ANDROID operation system. Any of the one or more user computing devices 111c1-111c3 may comprise one or more processors and/or one or more memories for storing, implementing, or executing computing instructions or code, e.g., a mobile application, as described in various aspects herein. As shown in FIG. 1, a visualizer application (app) 150, or at least portions thereof, may also be stored locally on a memory of a user computing device (e.g., user computing device 111c1). The visualizer app 150 comprises an application executable on a computing device for rendering or otherwise visualizing virtual 3D store environments (e.g., virtual 3D store environment 400B), for example, as described in various aspects herein.

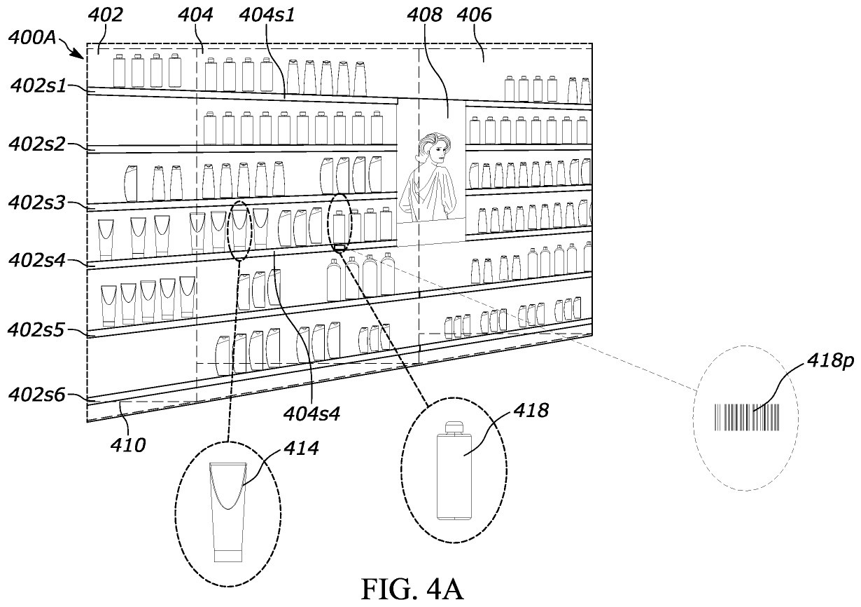

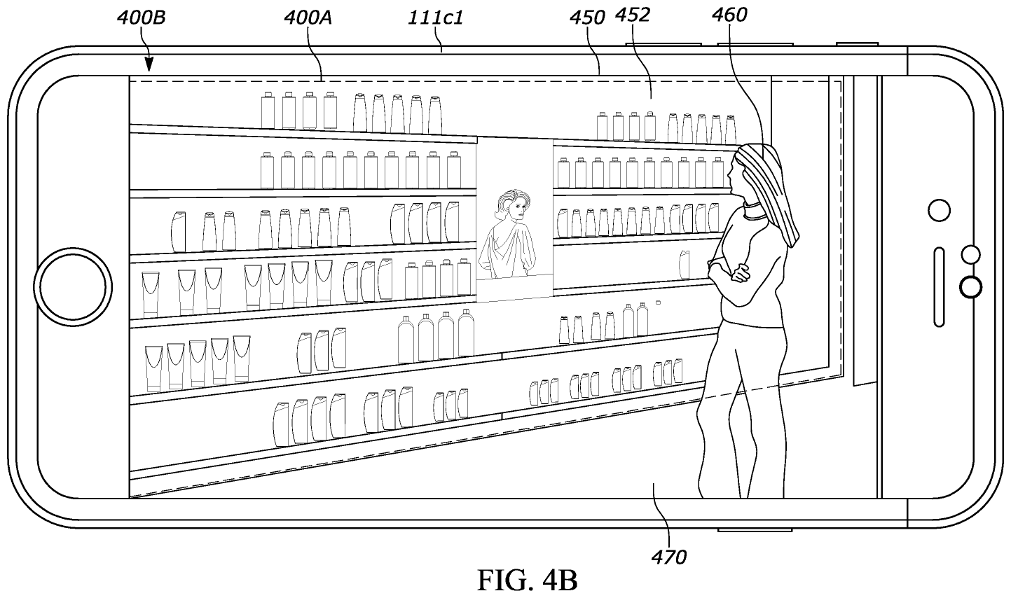

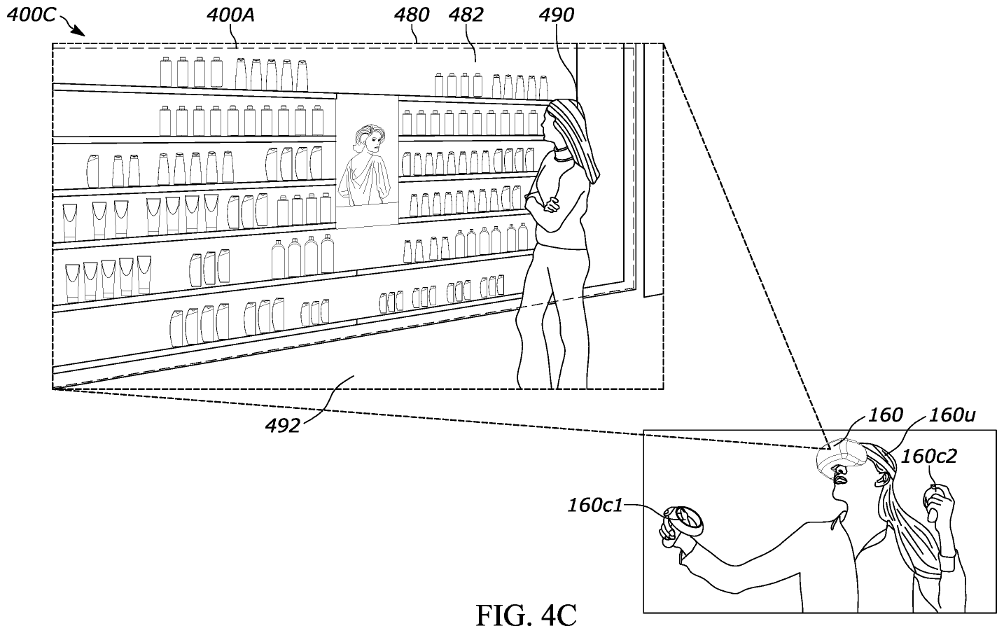

User computing devices 111c1-111c3 may comprise a wireless transceiver to receive and transmit wireless communications 121 and/or 122 to and from base station 111b. In various aspects, virtual 3D store environment(s) may be transmitted via computer network 120 to any one or more of computing devices 111c1-111c3 (e.g., computing device 111c1), e.g., for rendering as a photorealistic environment in virtual 3D space thereon. For example, virtual 3D store environment 400B is an example virtual 3D store environment that may be rendered on a computing device 111c1. The virtual 3D store environment 400B may comprise an interactive virtual environment such as a virtual aisle, such as 20 to 40 foot virtual retail store aisle that comprises virtual shelving units and shelves holding 3D rendered products. The virtual environment may be based on planogram and/or related planogram matrix file of real-world physical environment, e.g., such as a real-world retail environment. In addition, real-world products may be automatically added to the virtual environment by incorporating or otherwise defining such products as 3D assets in the virtual 3D store environment(s). This example is further described herein for FIGS. 4A and 4B.

Still further, each of the one or more user computer devices 111c1-111c3 may include a display screen for displaying graphics, images, text, 3D models, 3D environment(s) (e.g., such as 3D store environment(s), and/or other such visualizations or information as described herein. In various aspects, graphics, images, text, 3D models, 3D environment(s) (e.g., such as 3D store environment(s), and/or other such visualizations or information may be received from imaging server(s) 102 for display on the display screen of any one or more of user computer devices 111c1-111c3. Additionally, or alternatively, a user computer device may comprise, implement, have access to, render, or otherwise expose, at least in part, an interface or a guided user interface (GUI) for displaying text and/or images on its display screen. In various aspects, a display screen (e.g., display screen 450 as described for FIG. 4B herein) can also be used for providing instructions or guidance to the user of a given device (e.g., user computing device 111c1). The display screen may implement a standard display or interface (e.g., 2D or 3D rendered display or interface) or may also comprise a VR and/or AR display or interface.

For example, as shown in the example of FIG. 1, a VR headset 160 may be used by a user to view a virtual 3D store environment as a photorealistic environment in virtual 3D space. The virtual 3D store environment may be rendered on a display screen associated with the VR headset or otherwise VR device. This is further exemplified by FIGS. 4B and 4C herein.

More generally, VR devices may comprise VR headsets (e.g., VR headsets 107 and 160) that can include computing device capable of visualizing digital images for creating a virtual reality experience for the user. In some embodiments, for example, VR headsets 107 and 160 may be any commercial VR device, such as a GOOGLE CARDBOARD device, an OCULUS QUEST device, a PLAYSTATION VR device, a SAMSUNG GEAR VR device, or an HTC VIVE device. Each of these VR devices or headsets may include, or be associated with, one or more processors capable of visualizing digital images in virtual reality. For example, the GOOGLE CARDBOARD VR device comprises a physical cardboard housing that embeds a smart phone and that uses one or more processors of the smart phone, which can be a GOOGLE ANDROID-based or APPLE IOS-based smart phone, or other similar computing device (e.g., user computing device 111c1) to visualize the digital images in virtual reality. Other VR devices, such as the OCULUS QUEST VR device, may include a VR headset that uses one or more processors of a computing device, such a personal computer or laptop 111c3, for visualizing digital images in virtual reality. The personal computer or laptop 111c3 may include one or more processors, one or more computer memories, and software or computer instructions for performing visualizations of virtual 3D environment(s) (e.g., virtual 3D store environment(s)) as described herein. Still further, other VR devices may include one or more processors as part of a VR headset and that can operate independently from the processor(s) of a different computing device for the purpose of visualizing digital images in virtual reality.

In various embodiments, the VR headsets 107 and 160 may include embedded sensors that track a user's head motions and adjust the viewpoint of a VR visualization to simulate a virtual reality environment, giving the user the sensation that the user is looking around within a 3D environment or otherwise 3D world. In some embodiments, the embedded sensors may be sensors associated with the mobile device, computing device, or other computing device that is embedded in the VR headset. In other embodiments, the sensors may be part of the VR device itself.

In various embodiments, VR headset 107 and/or VR headset 160, can include input controls. For example, in some embodiments, the inputs control can be push buttons located on the VR devices 107 and/or 160. In other embodiments, the buttons can include magnets attached to the VR device's housing (e.g., GOOGLE CARDBOARD housing), where the magnets interact with a computing device embedded in the VR headset, such as a smart phone (e.g., user computing device 111c1), to cause the computing device to sense (e.g., via a magnetometer located in the computing device) movements of the magnet when pressed, thereby acting as an input source for the VR device. In other embodiments the input controls may include separate joysticks or wired or wireless controllers (e.g., one or more controllers 160c1 and/or 106c2 as shown for FIG. 4C) that a user may manipulate by hand to control the VR device and/or visualizations of the VR device. Still further, in other embodiments, the VR device, or its associated smart phone (e.g., user computing device 111c1) or personal computer or laptop 111c3, may allow input commands via voice or body gestures to control the VR device and/or visualizations of the VR device.

In various embodiments, the input controls of the VR devices, such as VR headset 107 and VR headset 160, allow a user to interact with the VR visualization (e.g., 3D environment), where the user, wearing a VR device, such as VR headset 107 or VR headset 160, can provide input to analyze, review, augment, annotate, or otherwise interact with the VR visualization (e.g., 3D environment). In some embodiments, a user may use the input controls to select from a menu or list displayed within the VR visualization. For example, the displayed menu or list may include options to navigate or highlight certain views or features of the VR visualization (e.g., 3D environment). In other embodiments, graphics or items may be interactive or selectable within the VR visualization (e.g., 3D environment). Still further, in other embodiments, the user may provide textual, graphical, video or other input to the VR visualization in order to augment, or annotate the VR visualization. In some embodiments, augmentation or annotation of the VR visualization will cause the augmentation or annotations to appear in the digital image(s), upon which the VR visualization is based, and/or vice versa.

In various embodiments, the input controls (e.g., one or more controllers 160c1 and/or 106c2 as shown for FIG. 4C) may be used with a crosshair or other indicator visible to the user within the VR visualization, such that the user hovering the crosshair or other indicator over a menu, list, graphic, text, video, or other item within the visualization can allow the user to interact with item, such as by clicking, pushing, grabbing, moving or otherwise interacting with the item by selecting the input control to confirm a selection or otherwise manipulate (e.g., in 3D space) the item that the crosshair or other indicator is focused on.

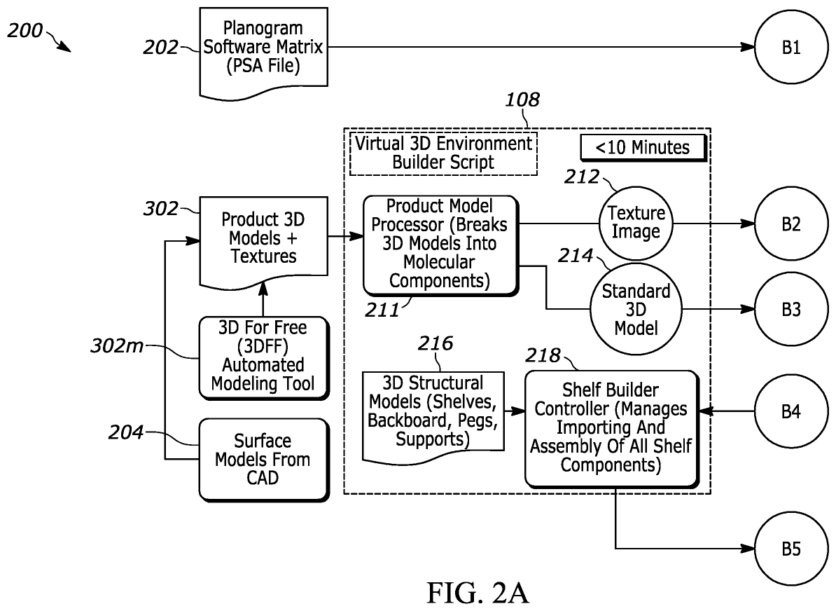

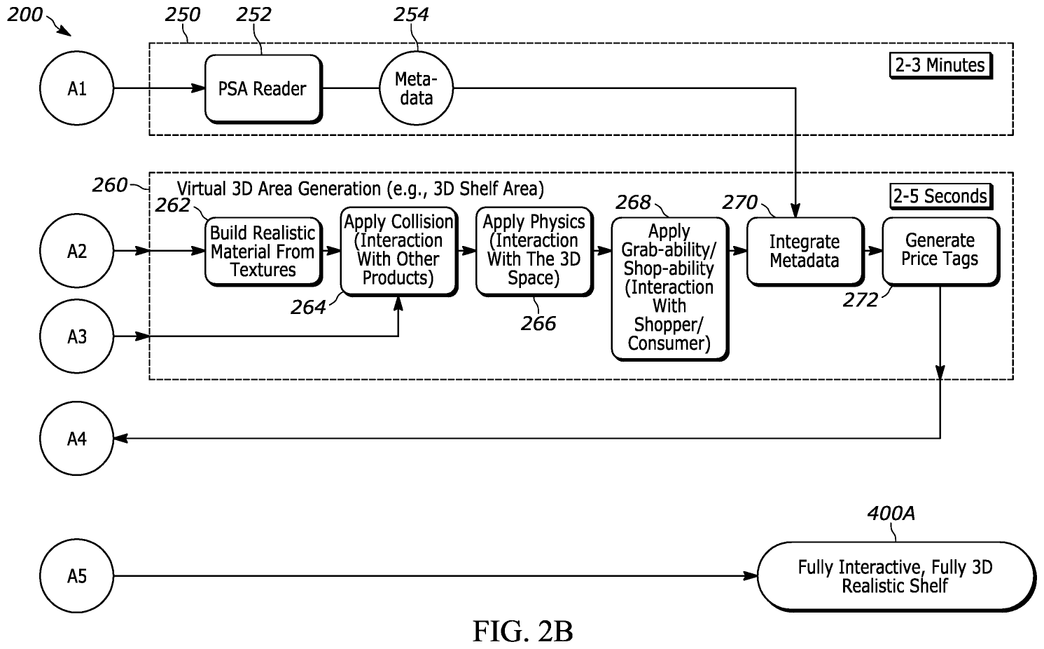

In various aspects, the 3D image modeling system 100, as describe herein, comprises one or more processors (e.g., CPU 104) and a virtual 3D environment builder script 108 comprising computing instructions configured to execute on the one or more processors. The 3D image modeling system 100 further comprises a memory (e.g., memory 106) configured to store 3D imaging assets accessible by the one or more processors and the computing instructions of the virtual 3D environment builder script 108. The 3D imaging assets may include, for example, product 3D models, textures, and/or 3D structural models. The computing instructions of the virtual 3D environment builder script 108, when executed by the one or more processors, may cause the one or more processors to implement the algorithm as described by FIGS. 2A and 2B herein.

FIG. 2A illustrates a flow diagram depicting a portion of a three-dimensional (3D) image modeling method 200 for automatically generating virtual 3D store environments, in accordance with various aspects disclosed herein. Further, FIG. 2B illustrates a further flow diagram depicting a further portion of the 3D image modeling method 200 of FIG. 2A for automatically generating virtual 3D store environments, in accordance with various aspects disclosed herein. Portions B1, B2, B3, B4, and B5 in FIG. 2A show or illustrate flow of method 200 to and/or from portions A1, A2, A3, A4, and A5 in FIG. 2B. It is to be understood that 3D image modeling method 200 may be implemented by computing instructions as executing on one or more processors (e.g., processor 104). In various aspects, method 200 illustrates computing instructions of virtual 3D environment builder script 108 that implements an algorithm according to the flow chart or flow diagram of FIGS. 2A and 2B.

As shown in FIG. 2A, method 200 comprises a virtual 3D environment builder script 108. In the example FIG. 2A, virtual 3D environment builder script 108 comprises a virtual 3D shelf building script for generating a virtual area, such as a shelf area, that comprises virtual objects (e.g., virtual products such as shampoo bottles). An example of such virtual 3D area is described herein for virtual 3D area 400A, which depicts virtual products as shampoo bottles on a virtual shelf.

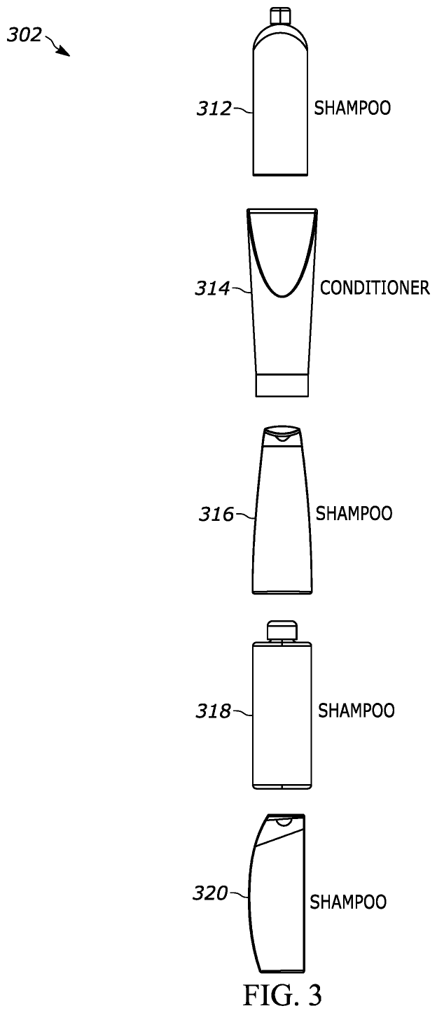

At block 302, method 200 comprises loading, from a memory (e.g., memory 106), a product set of 3D imaging assets (e.g., product set of 3D imaging assets 302) comprising product texture images and one or more standard product models. For example, FIG. 3, as described further herein, provides an example of a product set of 3D imaging assets 302 of various virtual shampoo bottles that comprise product texture images and standard product models (e.g., 3D UNITY game engine) for generating virtual 3D area 400A.

At block 202, method 200 comprises loading, from the memory, a matrix file (e.g., a planogram matrix file (e.g., for example, a PSA file) comprising metadata of a virtual product area. In various aspects, the virtual product area may comprise a 3D shelf or aisle of a retail area. Additionally, or alternatively, the virtual product area may comprise an e-commerce page.

With reference to FIG. 2B, the matrix file may be provided to an extractor 250 that comprises a PSA reader 252. PSA reader 252 extracts metadata 254, the latter of which may comprise metadata of a virtual product area. Additionally, or alternatively, the metadata may comprise additional information or data such as one or more of Global Trade Item Number (GTIN) information, pricing information, position information, product dimensional data, pack format data, and/or one or more two-dimensional (2D)s images. The metadata 254 may be provided to or used to generate a virtual 3D area, for example, as described for block 260.

At block 260, method 200 comprises generating, by a 3D engine inputting the matrix file or its related data (e.g., as described for extractor 250), a virtual 3D area (e.g., virtual 3D area 400A showing a shelving area) depicting one or more 3D products (e.g., products 314 and 318 as shown for FIGS. 3 and/or 4A). In various aspects, the 3D engine may comprise the UNITY game engine or the UNREAL game engine. In such aspects, the 3D engine positions the one or more virtual 3D products (e.g., products 314 and 318) within the virtual 3D area based on positioning data in the matrix file.

At block 262, method 200 comprises generating photo-realistic material or surfaces from the textures of the product set of 3D imaging assets as described for FIG. 2A. The photo-realistic material or surfaces may comprise generating a photo-realistic layer or skin for 3D models of one or more products (e.g., 3D models of shampoo bottles as described herein). The layers or skins or skins may then be mapped to, or otherwise applied to, the 3D imaging assets to create the photo-realistic 3D models of one or more products.

At block 264, method 200 comprises configuring the one or more products with collision (e.g., interaction between or among products) within the virtual 3D area (e.g., shelving area). Application of collision information allows the products to appear to physically interact with one another in the virtual 3D area (e.g., bumping, friction, etc.).

At block 266, method 200 comprises configuring the one or more products with physical motion (e.g., physics) within the virtual 3D area (e.g., shelving area). For example, physics may be added to the products and/or interactive virtual environment to make them interactive, e.g., gravity feed bins for products, carts and/or baskets being pushed down an aisle, or other physical interaction that may occur in the virtual 3D area and/or virtual 3D store environment.

At block 268, method 200 comprises configuring the one or more products with interaction (e.g., grab-ability of products by users) within the virtual 3D area (e.g., shelving area). Applying product interaction allows a user, or a user avatar, to virtually grab and interact with a product, which may include, for example, grabbing a product where the product is shown connected to the user, virtual hand(s) of a user, or an avatar of the user. Additional, or alternatively, grabbing a product may launch a mini-display or pop-up display with information (e.g., pricing and/or description) of the product.

At block 270, method 200 comprises integrating metadata 254 into the product(s), 3D model(s), and/or virtual 3D area. This could comprise applying lighting to the product(s), 3D model(s), and/or virtual 3D area. This could further comprise positioning the product(s) and/or 3D model(s) within the virtual 3D area.

At block 272, method 200 comprises generating a price tag for at least one product of the one or more products within the virtual 3D area and positioning the price tag on a 3D shelf of the virtual 3D area in a proximity to the at least one product. This can include adding pricing information and/or labels for products placed in a virtual environment. For example, 3D product 418 of FIG. 4A shows a price tag 418p that has been added to a 3D shelf in a proximity to the position of product 418. It should be understood, however, that price tags may be added to the 3D area for a plurality of the products therein, where such price tags are positioned in a proximity (e.g., underneath or above) respective products to which they correspond or are otherwise associated with. Additionally, or alternatively, the price tag(s) may be added to the products themselves (e.g., added to product 418), such as placed on a side or surface of the respective products. The finalized virtual 3D area (e.g., shelving area) can then be provided or analyzed by virtual 3D environment builder script 108, which may comprise a shelf builder controller 218, as illustrated by FIG. 2A. The shelf builder controller 218 imports and assembles all shelf components, including the virtual 3D area as generated in block 260 and the 3D structural models as provided for block 216.

With reference to FIGS. 2A and 2B, at block 218, method 200 comprises generating a virtual 3D store environment (e.g., virtual 3D store environment 400B) based on the virtual 3D area 400A and the 3D structural model. As shown in the example of FIG. 4B, the virtual 3D store environment may depict products as arranged on a shelf.

In various aspects, the virtual 3D store environment 400B is configured for rendering as a photorealistic environment in virtual 3D space, such as a virtual retail space or environment. The virtual 3D store environment may be rendered in real time, for example, where virtual environment can be immediately and/or constantly updated. As illustrated for FIGS. 2A and 2B, virtual 3D environment builder script 108 can perform each of the blocks of method 200 in under 10 minutes, and with reduced processor and memory requirements compared to existing techniques.

FIG. 3 illustrates a visualization or rendering of an example product set of 3D imaging assets, in accordance with various aspects disclosed herein. FIG. 3 provides an example of a product set of 3D imaging assets 302 of various virtual shampoo bottles that comprise product texture images and standard product models. The 3D imaging assets 302 may be associated with respective real-world products or product packages. The example of FIG. 3 illustrates a visualization or rendering of several possible 3D imaging assets, such as a symmetrical pump 3D model 312, a tube 3D model 314, a symmetrical bottle 3D model 316, a tottle 3D model 318, and an asymmetrical bottle 3D model 320, in accordance with various aspects disclosed herein. Each of the 3D models may comprise or be associated with metadata or information, such as texture images to be applied to the 3D models. The textures may be used to render the 3D models within virtual 3D store environment(s). In addition, such 3D imaging assets may be stored in the memory 106 and/or database 105. It is to be understood that additional and/or different 3D models may be used as well.

In various aspects, the 3D imaging assets 302 corresponding to a particular real-world product or product package may be virtually modeled in 3D space, e.g., in virtual 3D store environment, by the virtual 3D environment builder script 108. For instance, 3D model defining a real-world product or product package to be virtually placed in 3D space and may be obtained or extracted from the database 105, e.g., by the virtual 3D environment builder script 108. Additionally, a dimensional dataset defining product or package measurements of the same real-world product or product package may be obtained or extracted from the database 105, e.g., by the virtual 3D environment builder script 108. Such 3D imaging assets 302 may be used to generate, by a 3D engine inputting the matrix file (e.g., comprising metadata of a virtual product area), a virtual 3D area within which the one or more 3D products may be positioned. In particular, the 3D engine may position the one or more virtual 3D products based on positioning data in the matrix file.

FIG. 4A illustrates an example virtual 3D area 400A depicting one or more 3D products (e.g., 3D product 414 and 3D product 418), in accordance with various aspects disclosed herein. Virtual 3D area 400A is depicted as a shelving area, which may be generated as described herein by the algorithm of method 200. As shown for FIG. 4A, virtual 3D area 400A comprises 3D shelving units 402, 404, and 406 that are shown positioned next to each within virtual 3D area 400A. The 3D shelving units 402, 404, and 406, their respective dimensions, structural elements, and other features, such as how many shelves per shelving unit, may be loaded from memory 106 and/or database 105. Such information may be part of the structural set of 3D imaging assets as described for block 216 herein. In various aspects, each shelving unit may be defined by a number of shelves. For example, shelving unit 402 is defined by or comprises shelves 402s1, 402s2, 402s3, 402s4, 402s5, and 402s6. Similarly, shelving unit 404 is defined by or comprises at least shelves 404s1 and 404s4, or as otherwise depicted. Shelving unit 406 likewise defines or is comprised by shelves as depicted. Other feature or artifacts, such as text or signage 408, may also be loaded from memory 106 and/or 105, which may be part of structural set of 3D imaging assets. The Virtual 3D area 400A, comprising a set of shelves, may also comprise other areas such as a shelf bottom portion 410 designed to snap or rest on a virtual floor of a virtual 3D store environment, e.g., as shown in FIG. 4B.

In addition, virtual 3D area 400A further depicts various virtual 3D products that are positioned within, or on the shelves, of shelving units 402, 404, and 406. As examples, virtual 3D product 414 and virtual 3D product 418 are each positioned on shelf 404s4 of shelving unit 404. As shown, virtual 3D products 414 and 418 are depicted as shampoo bottles. Virtual 3D products 414 and 418 may comprise photorealistic versions based on 3D models 314 and 318 as described by FIG. 3, respectively. Virtual 3D products 414 and 418 may be rendered by method 200, which may include applying collision, physics, lighting, and/or other attributes to 3D models 314 and 318 to create photorealistic versions that may be placed into virtual 3D area 400A. Virtual 3D products 418 includes price tag 418p, which was included during rendering as described for method 200.

FIG. 4B illustrates example virtual 3D store environment based on the virtual 3D area 400A of FIG. 4A, in accordance with various aspects disclosed herein. The example of FIG. 4B includes an example graphic user interface (GUI) 452 as rendered on a display screen 450 of a user computing device (e.g., user computing device 111c1), in accordance with various aspects disclosed herein. GUI 452 is an example depicting a rendering of what a user may experience when the virtual 3D store environment is rendered as a photorealistic environment in a virtual 3D space as described for FIGS. 1, 2A, and 2B herein. For example, as shown in FIG. 4B, GUI 452 may be implemented or rendered via an app executing on user computing device 111c1. In some aspects, GUI 452 may be implemented or rendered via a native app executing on user computing device 111c1. In the example of FIG. 4B, user computing device 111c1 is a user computer device as described for FIG. 1, e.g., where 111c1 is illustrated as an APPLE IPHONE that implements the APPLE iOS operating system and that has display screen 450. User computing device 111c1 may execute one or more native applications (apps) on its operating system, including, for example, an app (e.g., visualizer app 150) as described herein. Such native apps may be implemented or coded (e.g., as computing instructions) in a computing language (e.g., SWIFT) executable by the user computing device operating system (e.g., APPLE iOS) by the processor of user computing device 111c1. In various aspects, app 150 may be configured to display content to the user, including virtual 3D store environment(s) and/or other information, data, or images as described herein.

Additionally, or alternatively, GUI 452 may be implemented or rendered via a web interface, such as via a web browser application, e.g., SAFARI and/or CHROME based web browsers, browser apps, and/or other such web browser or the like. In such aspects, the web browser would return HTML code provided by, or otherwise associated with, the server(s) 102.

As shown for FIG. 4B, the virtual 3D store environment 400B may comprise an interactive virtual environment such as a virtual aisle 470 (e.g., a 20 to 40 foot aisle of a retail space) that comprises virtual shelves. The virtual environment may be based on planogram and/or related planogram matrix file of real-world physical environment, e.g., such as a real-world retail environment. In addition, real-world product may be automatically added to the virtual environment by incorporating or otherwise defining such products as 3D assets, such as products, e.g., shampoo bottles, in the virtual 3D store environment 400B, such as described for method 200 herein.

A user may interact with the virtual 3D store environment 400B via an avatar 460. For example, a user, manipulating a user computing device (e.g., user computing device 111c1) and visualizer app 150 may control the avatar 460 to interact with (e.g., grab or otherwise manipulate) the products (e.g., virtual 3D products 414 and 418) on the shelves. Additionally, or alternatively, one or more virtual hands (not shown) for interacting with the environment may be used. For example, the one or more virtual hands may be controlled by the user to grab, via a VR or AR app, to grab, inspect, or otherwise interact with products within the virtual 3D store environment 400B.

In some aspects, visualizer app 150 comprises an app that renders virtual 3D store environment 400B as 2D and/or 3D application on a display screen of the mobile device. In other aspects, visualizer app 150 may comprise a virtual reality (VR) or augmented reality (AR) app that renders virtual 3D store environment 400B in an VR or an AR mode, respectively, such as via a GOOGLE CARDBOARD software, where the user may have an interactive VR or AR experience within the virtual 3D store environment 400B device.

FIG. 4C illustrates a further example virtual 3D store environment based on the virtual 3D area 400A of FIG. 4A and as viewed via a virtual reality (VR) device (e.g., a virtual reality headset 160), in accordance with various aspects disclosed herein. The example of FIG. 4C includes an example graphic user interface (GUI) 482 as rendered on a display screen 480 of a VR device (e.g., virtual reality headset 160), in accordance with various aspects disclosed herein. GUI 482 is an example depicting a rendering of what a user 160u may experience when the virtual 3D store environment is rendered as a photorealistic environment in a virtual 3D space as described for FIGS. 1, 2A, and 2B herein. For example, as shown in FIG. 4C, GUI 482 may be implemented or rendered via a virtually reality app (e.g., visualizer app 150) executing on, or associated with, VR headset 160. In some aspects, GUI 452 may be implemented or rendered via a native app (e.g., visualizer app 150) executing on VR headset 160. In the example of FIG. 4C, VR headset 160 is a VR device as described for FIG. 1, e.g., where VR headset 160 is illustrated as an OCULUS QUEST VR headset that implements it corresponding software and/or app for display of VR visualization on its display screen 480. VR headset 160 may execute its software or app on an operating system, including, for example, an operating system of a user computing device and/or VR headset itself. Such native apps may be implemented or coded (e.g., as computing instructions) in a computing language (e.g., Java or other similar language) executable by the VR Headset or its related software. In various aspects, app 150 may be configured to display content to the user, including virtual 3D store environment(s) and/or other information, data, or images as described herein via the VR headset 160.

As shown for FIG. 4C, the virtual 3D store environment 400C may comprise an interactive virtual environment such as a virtual aisle 492 (e.g., a 20 to 40 foot aisle of a retail space) that comprises virtual shelves. The virtual environment may be based on planogram and/or related planogram matrix file of real-world physical environment, e.g., such as a real-world retail environment. In addition, real-world product may be automatically added to the virtual environment by incorporating or otherwise defining such products as 3D assets, such as products, e.g., shampoo bottles, in the virtual 3D store environment 400C, such as described for method 200 herein.

A user may interact with the virtual 3D store environment 400B via an avatar 490, virtual hand(s), and/or one or more controllers 160c1 and/or 106c2. For example, a user, manipulating controllers 160c1 and/or 106c2 of VR headset 160 may control the avatar 490 and/or virtual hands to interact with (e.g., grab or otherwise manipulate) the products (e.g., virtual 3D products 414 and 418) on the shelves. In such aspects, visualizer app 150 may comprise an interface allowing a user to use a VR headset or device (e.g., VR headset 160) to have an interactive VR experience within the virtual 3D store environment 400C by using and interacting with the VR headset or device (e.g., VR headset 160) and its related controllers (e.g., one or more controllers 160c1 and/or 106c2). The user may view or interact with products (e.g., virtual 3D products 414 and 418) or otherwise navigate or explore the virtual 3D store environment 400C by using and interacting with the VR headset or device (e.g., VR headset 160).

Aspects of the Disclosure

1. A three-dimensional (3D) image modeling system configured to automatically generate virtual 3D store environments, the 3D image modeling system comprising: one or more processors; a virtual 3D environment builder script comprising computing instructions configured to execute on the one or more processors; and a memory configured to store 3D imaging assets accessible by the one or more processors and the computing instructions of the virtual 3D environment builder script, wherein the computing instructions of the virtual 3D environment builder script, when executed by the one or more processors, cause the one or more processors to: load, from the memory, a product set of 3D imaging assets comprising product texture images and one or more standard product models, load, from the memory, a structural set of 3D imaging assets comprising a 3D structural model, load, from the memory, a matrix file comprising metadata of a virtual product area, generate, by a 3D engine inputting the matrix file, a virtual 3D area depicting one or more 3D products, wherein the 3D engine positions the one or more virtual 3D products based on positioning data in the matrix file, and generate a virtual 3D store environment based on the virtual 3D area and the 3D structural model, wherein the virtual 3D store environment is configured for rendering as a photorealistic environment in virtual 3D space.

2. The 3D image modeling system of aspect 1, wherein the metadata comprises one or more of Global Trade Item Number (GTIN) information, product pricing information, product position data, product dimensional data, pack format data, or one or more two-dimensional (2D)s images.

3. The 3D image modeling system of any one of aspects 1-2, wherein the 3D structural model comprises a 3D shelf.

4. The 3D image modeling system of any one of aspects 1-3, wherein the one or more products are configured with at least one of: collision within the virtual 3D area; physical motion with in the 3D area; or interaction within the virtual 3D area.

5. The 3D image modeling system of any one of aspects 1-4, wherein the virtual 3D store environment is rendered in real time.

6. The 3D image modeling system of any one of aspects 1-5, wherein the computing instructions of the virtual 3D environment builder script, when executed by the one or more processors, cause the one or more processors to: generate a price tag for at least one product of the one or more products within the virtual 3D area and position the price tag on a 3D shelf of the virtual 3D area in a proximity to the at least one product.

7. A three-dimensional (3D) image modeling method for automatically generating virtual 3D store environments, the 3D image modeling method comprising: loading, from a memory, a product set of 3D imaging assets comprising product texture images and one or more standard product models; loading, from the memory, a structural set of 3D imaging assets comprising a 3D structural model; loading, from the memory, a matrix file comprising metadata of a virtual product area; generating, by a 3D engine inputting the matrix file, a virtual 3D area depicting one or more 3D products, wherein the 3D engine positions the one or more virtual 3D products based on positioning data in the matrix file; and generating a virtual 3D store environment based on the virtual 3D area and the 3D structural model, wherein the virtual 3D store environment is configured for rendering as a photorealistic environment in virtual 3D space.

8. The 3D image modeling method of aspect 7, wherein the metadata comprises one or more of Global Trade Item Number (GTIN) information, product pricing information, product position data, product dimensional data, pack format data, or one or more two-dimensional (2D)s images.

9. The 3D image modeling method of any one of aspects 7-8, wherein the 3D structural model comprises a 3D shelf.

10. The 3D image modeling method of any one of aspects 7-9, wherein the one or more products are configured with at least one of: collision within the virtual 3D area; physical motion with in the 3D area; or interaction within the virtual 3D area.

11. The 3D image modeling method of any one of aspects 7-10, wherein the virtual 3D store environment is rendered in real time.

12. The 3D image modeling method of any one of aspects 7-11 further comprising: generating a price tag for at least one product of the one or more products within the virtual 3D area, and positioning the price tag on a 3D shelf of the virtual 3D area in a proximity to the at least one product.

13. A tangible, non-transitory computer-readable medium storing computing instructions for automatically generating virtual 3D store environments, that, when executed by one or more processors, cause the one or more processors to: load, from a memory, a product set of 3D imaging assets comprising product texture images and one or more standard product models; load, from the memory, a structural set of 3D imaging assets comprising a 3D structural model; load, from the memory, a matrix file comprising metadata of a virtual product area; generate, by a 3D engine inputting the matrix file, a virtual 3D area depicting one or more 3D products, wherein the 3D engine positions the one or more virtual 3D products based on positioning data in the matrix file; and generate a virtual 3D store environment based on the virtual 3D area and the 3D structural model, wherein the virtual 3D store environment is configured for rendering as a photorealistic environment in virtual 3D space.

14. The tangible, non-transitory computer-readable medium of aspect 13, wherein the metadata comprises one or more of Global Trade Item Number (GTIN) information, product pricing information, product position data, product dimensional data, pack format data, or one or more two-dimensional (2D)s images.

15. The tangible, non-transitory computer-readable medium of any one of aspects 13-14, wherein the 3D structural model comprises a 3D shelf.

16. The tangible, non-transitory computer-readable medium of any one of aspects 13-15, wherein the one or more products are configured with at least one of: collision within the virtual 3D area; physical motion with in the 3D area; or interaction within the virtual 3D area.

17. The tangible, non-transitory computer-readable medium of any one of aspects 13-16, wherein the virtual 3D store environment is rendered in real time.

18. The tangible, non-transitory computer-readable medium of any one of aspects 13-17, wherein the computing instructions, when executed by the one or more processors, cause the one or more processors to: generate a price tag for at least one product of the one or more products within the virtual 3D area and position the price tag on a 3D shelf of the virtual 3D area in a proximity to the at least one product.

Additional Considerations

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various aspects, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In aspects in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A three-dimensional (3D) image modeling system configured to automatically generate virtual 3D store environments, the 3D image modeling system comprising:
one or more processors;
a virtual 3D environment builder script comprising computing instructions configured to execute on the one or more processors; and
a memory configured to store 3D imaging assets accessible by the one or more processors and the computing instructions of the virtual 3D environment builder script,
wherein the computing instructions of the virtual 3D environment builder script, when executed by the one or more processors, cause the one or more processors to:
load, from the memory, a product set of 3D imaging assets comprising product texture images and one or more standard product models,
load, from the memory, a structural set of 3D imaging assets comprising a 3D structural model,
load, from the memory, a matrix file comprising metadata of a virtual product area,
generate, by a 3D engine inputting the matrix file, a virtual 3D area depicting one or more 3D products, wherein the 3D engine positions the one or more virtual 3D products based on positioning data in the matrix file, and
generate a virtual 3D store environment based on the virtual 3D area and the 3D structural model,
wherein the virtual 3D store environment is configured for rendering as a photorealistic environment in virtual 3D space.

2. The 3D image modeling system of claim 1, wherein the metadata comprises one or more of Global Trade Item Number (GTIN) information, product pricing information, product position data, product dimensional data, pack format data, or one or more two-dimensional (2D)s images.

3. The 3D image modeling system of claim 1, wherein the 3D structural model comprises a 3D shelf.

4. The 3D image modeling system of claim 1, wherein the one or more products are configured with at least one of: collision within the virtual 3D area; physical motion with in the 3D area; or interaction within the virtual 3D area.

5. The 3D image modeling system of claim 1, wherein the virtual 3D store environment is rendered in real time.

6. The 3D image modeling system of claim 1, wherein the computing instructions of the virtual 3D environment builder script, when executed by the one or more processors, cause the one or more processors to:
generate a price tag for at least one product of the one or more products within the virtual 3D area and position the price tag on a 3D shelf of the virtual 3D area in a proximity to the at least one product.

7. A three-dimensional (3D) image modeling method for automatically generating virtual 3D store environments, the 3D image modeling method comprising:
loading, from a memory, a product set of 3D imaging assets comprising product texture images and one or more standard product models;
loading, from the memory, a structural set of 3D imaging assets comprising a 3D structural model;
loading, from the memory, a matrix file comprising metadata of a virtual product area;
generating, by a 3D engine inputting the matrix file, a virtual 3D area depicting one or more 3D products, wherein the 3D engine positions the one or more virtual 3D products based on positioning data in the matrix file; and
generating a virtual 3D store environment based on the virtual 3D area and the 3D structural model,
wherein the virtual 3D store environment is configured for rendering as a photorealistic environment in virtual 3D space.

8. The 3D image modeling method of claim 7, wherein the metadata comprises one or more of Global Trade Item Number (GTIN) information, product pricing information, product position data, product dimensional data, pack format data, or one or more two-dimensional (2D)s images.

9. The 3D image modeling method of claim 7, wherein the 3D structural model comprises a 3D shelf.

10. The 3D image modeling method of claim 7, wherein the one or more products are configured with at least one of: collision within the virtual 3D area; physical motion with in the 3D area; or interaction within the virtual 3D area.

11. The 3D image modeling method of claim 7, wherein the virtual 3D store environment is rendered in real time.

12. The 3D image modeling method of claim 7 further comprising:
generating a price tag for at least one product of the one or more products within the virtual 3D area; and
positioning the price tag on a 3D shelf of the virtual 3D area in a proximity to the at least one product.

13. A tangible, non-transitory computer-readable medium storing computing instructions for automatically generating virtual 3D store environments, that, when executed by one or more processors, cause the one or more processors to:
load, from a memory, a product set of 3D imaging assets comprising product texture images and one or more standard product models;
load, from the memory, a structural set of 3D imaging assets comprising a 3D structural model;
load, from the memory, a matrix file comprising metadata of a virtual product area;
generate, by a 3D engine inputting the matrix file, a virtual 3D area depicting one or more 3D products, wherein the 3D engine positions the one or more virtual 3D products based on positioning data in the matrix file; and
generate a virtual 3D store environment based on the virtual 3D area and the 3D structural model,
wherein the virtual 3D store environment is configured for rendering as a photorealistic environment in virtual 3D space.

14. The tangible, non-transitory computer-readable medium of claim 13, wherein the metadata comprises one or more of Global Trade Item Number (GTIN) information, product pricing information, product position data, product dimensional data, pack format data, or one or more two-dimensional (2D)s images.

15. The tangible, non-transitory computer-readable medium of claim 13, wherein the 3D structural model comprises a 3D shelf.

16. The tangible, non-transitory computer-readable medium of claim 13, wherein the one or more products are configured with at least one of: collision within the virtual 3D area; physical motion with in the 3D area; or interaction within the virtual 3D area.

17. The tangible, non-transitory computer-readable medium of claim 13, wherein the virtual 3D store environment is rendered in real time.

18. The tangible, non-transitory computer-readable medium of claim 13, wherein the computing instructions, when executed by the one or more processors, cause the one or more processors to:
generate a price tag for at least one product of the one or more products within the virtual 3D area and position the price tag on a 3D shelf of the virtual 3D area in a proximity to the at least one product.
